(19) United States
(12) Patent Application Publication
(10) Pub. No.: US 2006/0168132 A1
(43) Pub. Date: Jul. 27, 2006

(54) Business messaging standards to web services

(75) Inventors: Paul R. Bunter, San Diego, CA (US); Ralph A. Hertlein, Alpharetta, GA (US); Sreedhar Janaswamy, Bangalore (IN); Rania Y. Khalaf, Cambridge, MA (US); Keeranoor G. Kumar, Randolph, NJ (US); Michael Mcntosh, Clifton, NJ (US); Anthony J. Nadalin, Austin, TX (US); Shishir Saxena, Ghaziabad (IN); Ralph Peter Williams, Danville, CA (US)

Correspondence Address: Derek S. Jennings;Intellectual Property Law Dept., IBM Corporation, P.O. Box 218, Yorktown Heights, NY, 10598, US

(73) Assignee: INTERNATIONAL BUSINESS MACHINES CORPORATION, ARMONK, NY (US)

(21) Appl. No.: 11/264,355

(22) Filed: Oct. 31, 2005

Related U.S. Application Data
(60) Provisional application No. 60/623,437, filed on Oct. 29, 2004.

(51) Int. Cl. G06F 15/16

(52) U.S. Cl. 709/219

(57) ABSTRACT

A web services framework consists of a modular, extensible stack of XML specifications and standards targeting the emerging infrastructure in which distributed, heterogeneous applications are exposed by different organizations as services on the Internet. These services have their capabilities described and published in a machine readable format.

### RELATED APPLICATIONS

This patent application claims priority to applicants' earlier provisional patent application 60/623,437 entitled “Business Messaging Standards to Web Services”, filed on Oct. 29, 2004.

### FIELD OF THE INVENTION

The present invention relates to aspects of adapting various Industry Standards-based Business Messaging Systems to leverage the benefits of Web Services. It reviews the current functionality of Industry Standards such as CIDX, OAGi, PIDX and RosettaNet that use the RosettaNet Implementation Framework (RNIF) and the benefit of adapting them to a Web Services environment.

### BACKGROUND OF THE INVENTION

The majority of the Industry Business Messaging Standards in use today are developed by consortia of companies primarily from within specific industries. Their goal is to develop open standards and processes that enable trading partners to exchange standardized business messages within an e-business environment. Some of the standards such as RosettaNet are supported by major application vendors such as SAP, I2, Manugistics, and Oracle and all major middleware vendors, including IBM. Others are supported by the majority of middleware vendors and industry specific implementations.

Each industry consortium has created a large set of specifications that describe particular business interactions between trading partners. For example, these specifications are known within RosettaNet as Partner Interface Process (PIP) specifications and within the OAGIS Standard as Business Object Documents (BODs). They typically include information on the sequence of activities, the different roles involved in the interaction (ie, buyer and seller), the structure and content of the business messages to be exchanged, and various quality of service requirements such as timing constraints, security, and non-repudiation.

Currently, RosettaNet PIPs are packaged as a set of XML DTD, HTML, and Microsoft® Word files. The PIP-specific business message 100 formats are defined in the XML DTD files. The specification is given in the Microsoft® Word document and describes message exchange and business control parameters via UML diagrams, tables and text. Note that RosettaNet is in the process of converting its PIPs to use XML Schema. CIDX, OAGi (the organization responsible for OAGIS) and PIDX already package their messages as XML Schemas with XML documentation. A typical list of business messages for any of these consortia includes a minimum subset of Quote Request, Quote, Quote Notification, Order, Order Response, Order Change, Order Status Request, Receipt, Advanced Shipped Notice (ASN), Return Requisition Request, Field Ticket, Field Ticket Response, Invoice, Invoice Response, and Invoice Exception, see FIG. 1. OAGi and RosettaNet have much larger sets of messages covering, in addition, areas such as supply chain forecasting, product data exchange, manufacturing, design-win and product marketing.

The Business Message is the construct that is exchanged between trading partners and consists of multiple message components packaged together in a MIME multipart/related document. Typically, this consists of header documents, the business action/signal message (Service Content), and optional attachments. The RNIF, used by multiple consortia for their transport, defines the structure of the Business Message and the steps required for transmitting the message between trading partners. This includes message packaging and unpackaging, transmission protocols, error handling, and validation of some content.

Examples of other known art are as follows.

CIDX

RosettaNet Implementation Framework: Core Specification Version: V02.00.01

Revised: 6 Mar. 2002

http://www.cidx.org/ChemeStandards/download.asp

OAGi

RosettaNet Implementation Framework: Core Specification Version: V02.00.01

Revised: 6 Mar. 2002

http://www.openapplications.org/downloads/oagidownloads.htm

PIDX

RosettaNet Implementation Framework: Core Specification Version: V02.00.01

Revised: 6 Mar. 2002

http://committees.api.org/business/pidx/xmlnew.html

RosettaNet

RosettaNet Implementation Framework: Core Specification Version: V02.00.01

Revised: 6 Mar. 2002

http://www.rosettanet.org

WS-Addressing

Web Services Addressing (WS-Addressing) August 2004

http://www.w3.org/Submission/2004/SUBM-ws-addressing-20040810/

WS-BPEL (BPEL4WS)

Business Process Execution Language for Web Services Version 1.1 5 May 2003

http://www6.software.ibm.com/software/developer/library/ws-bpel.pdf

WS-I

Web Services Interoperability Organization is an open standards consortium charted to promote interoperable Web Services. They provide specifications, profiles and reference materials to guide implementers of Web Services.

Basic Profile 1.1—Final Specification Aug. 24, 2004

http://www.ws-i.org/Profiles/BasicProfile-1.1-2004-08-24.html

Simple SOAP Binding Profile 1.0—Final Specification Aug. 24, 2004

http://www.ws-i.org/Profiles/SimpleSoapBindingProfile-1.0-2004-08-24.html

Attachments Profile 1.0—Final Specification Aug. 24, 2004

http://www.ws-i.org/Profiles/AttachmentsProfile-1.0-2004-08-24.html

Basic Profile 1.0—Final Specification Aug. 16, 2004

http://www.ws-i.org/Profiles/BasicProfile-1.0-2004-04-16.html

Profile Conformance Framework WG Draft Nov. 15, 2004

http://www.ws-i.org/Profiles/ConformanceClaims-1.0-2004-11-15.html

Basic Security Profile Working Group Draft Aug. 29, 2005

http://www.ws-i.org/Profiles/BasicSecurityProfile-1.0.html

WS-Policy

Web Services Policy Framework (WS-Policy) May 2003

http://www6.software.ibm.com/software/developer/library/ws-policy2003.pdf

WS-PolicyAssertions

Web Services Policy Assertions Language (WS-PolicyAssertions) Dec. 18, 2003

http://www6.software.ibm.com/software/developer/library/ws-polas.pdf

WS-PolicyAttachment

Web Services Policy Attachment (WSPolicyAttachment) Jun. 2, 2003

http://www6.software.ibm.com/software/developer/library/ws-polat2003.pdf

WS-ReliableMessaging

Web Services Reliable Messaging Protocol (WS-ReliableMessaging) March 2004

http://www6.software.ibm.com/software/developer/library/ws-reliablemessaging200403.pdf

WS-Security

Web Services Security: SOAP Message Security 1.0 (WS-Security 2004)

OASIS Standard 200401, March 2004

http://docs.oasis-open.org/wss/2004/01/oasis-200401-wss-soap-message-security-1.0.pdf

WS-SecurityPolicy

Web Services Security Policy (WS-SecurityPolicy) Draft 18 December 2002

http://www6.software.ibm.com/software/developer/library/ws-secpol122002.pdf

WSDL—Web Services Description Language (WSDL) 1.1

W3C submission 15 Mar. 2001

http://www.w3.org/TR/wsdl

XML Schema

XML Schema Part 1: Structures, W3C Recommendation 2 May 2001

http://www.w3.org/TR/2001/REC-xmlschema-1-20010502/

XML Schema Part 2: Datatypes, W3C Recommendation 2 May 2001

http://www.w3.org/TR/2001/REC-xmlschema-2-20010502/

### SUMMARY OF THE INVENTION

Briefly, the invention comprises a web services framework consists of a modular, extensible stack of XML specifications and standards targeting the emerging infrastructure in which distributed, heterogeneous applications are exposed by different organizations as services on the Internet. These services have their capabilities described and published in a machine readable format.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF THE FIGURES

FIG. 1 illustrates a structure of a typical RosettaNet Business Message.

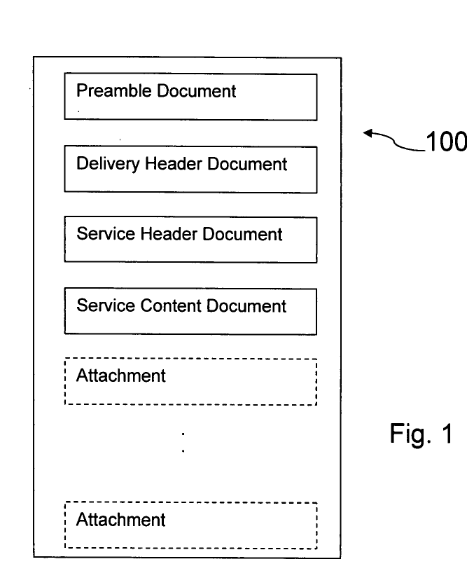

FIG. 2 illustrates part of a sample XML Schema a Purchase Order Request action message according to an embodiment of the present invention.

FIG. 3 illustrates part of a sample WSDL definition for the 3A4 Purchase Order Request action message according to an embodiment of the present invention.

FIG. 4 illustrates an SOAP message structure for a Business Message according to an embodiment of the present invention.

FIG. 5 illustrates an Abstract BPEL processes for each participant for submitting a PO according to an embodiment of the present invention.

FIG. 6 illustrates an Executable BPEL processes that comply with the Abstract and interacts with the back-ends according to an embodiment of the present invention.

FIG. 7 illustrates part of a sample showing WS-Security assertions according to an embodiment of the present invention.

FIG. 8 illustrates an example of a BPEL partnerLink definition according to an embodiment of the present invention.

FIG. 9 illustrates an example of a BPEL variable definition according to an embodiment of the present invention.

FIG. 10 illustrates an example BPEL control logic as used for web services according to an embodiment of the present invention.

FIG. 11 illustrates an example of a BPEL correlation set according to an embodiment of the present invention.

FIG. 12 illustrates an example BPEL timer logic being used for web services according to an embodiment of the present invention.

FIG. 13 illustrates an example abstract process using the PIP 3A4 Purchase Order Request according to an embodiment of the present invention.

FIGS. 14A-14D illustrate an example of a message with Proof of Message Origin according to an embodiment of the present invention.

FIG. 15 illustrates a Receipt Acknowledgement element according to an embodiment of the present invention.

### DETAILED DESCRIPTION OF THE PREFERRED EMBODIMENTS

Proposed is an approach that achieves existing functionality using Web Services tools, methods and standards available today or in the near future.

The approach outlined here applies to both the business messages and documents that contain business content and to the RNIF which provides the messaging infrastructure needed to exchange the business messages. For business content, it is proposed that each business message package consist of a set of XML Schemas, WSDL definitions, WS-Policy assertions, and abstract BPEL processes. The processes and infrastructure embodied within the RNIF are also proposed to be handled by the abstract BPEL processes along with other elements of a Web Services stack that includes WS-Security, WS-ReliableMessaging, WS-Addressing, WS-Policy and WS-PolicyAttachment. All Web Service-related sub-systems are expected to comply with Web Services—Interoperability (WS-I) profiles and specifications to ensure the maximum level of interoperability.

Now with several years of experience, the industry consortia are able to reflect on theory versus practice and also observe new business trends. For example, RosettaNet specification packaging makes installation more difficult than is desired. This impacts major users from scaling their e-business networks as rapidly as they would like. Selecting relevant information from the complex specification text is labor intensive and error-prone. With RosettaNet beginning to move to XML Schema specifications, this paper's proposals are timely, as schema based PIPs will be able to leverage Web Services as easily as the other consortia's messages. For the other consortia that are already schema based, it can be used to guide their transition from RNIF to Web Services.

At a minimum, Web Services offers an alternate channel to RNIF for exchanging business objects or messages. This alone makes it a logical candidate for consideration by these industry consortia. However, other compelling reasons exist for them to offer a Web Services option.

In the global landscape of business, enterprises conducting e-business among dynamic supply chains must be capable of equally dynamic communication from end-to-end, both upstream and downstream. Internal applications must be able to communicate information quickly and easily both intra and inter-enterprise. This requires a higher level of automated application integration.

Inter-enterprise business communications within increasingly disaggregated value chains effectively mandate the use of open standards. Open standards permit accurate, effective communication to be established among all partners within the product life cycle that transcend enterprises, vendors, infrastructures and platforms. Today, the market is choosing XML as the framework to enable heterogeneous messaging. However, there are still many more components needed to fulfill the range of capabilities business partners require to successfully automate the value chain.

Web Services hold the promise to answer the market demand for those additional components. Although the definition of Web Services sparks much discussion, there appears to be general agreement around the following: Web Services are modular applications that can be described, published, located, assembled, invoked and controlled using XML over a network. Using this definition, Web Services can be viewed as business service building blocks that can be assembled across multiple heterogeneous networks to create desired functionality. By providing remote application data and functions where desired, as if they were local, web services can offer the following benefits:

They enable the creation and packaging of discrete “service modules” which can be linked into more complete business processes. Variously linked modules in multiple combinations permit trading partners to answer their own questions and needs, in their own timeframe, by leveraging their partners' systems as if they were applications resident within their own system. Partners can then “extend” that information up or down chain quickly and easily with their own Web Services, offering the ability to extend the enterprise much faster and cheaper than the methods in use today. This in turn offers companies the ability to participate in specific supply chains faster and more easily; and as more enterprises field web services, to move across supply chains, greatly expanding the opportunities for any given enterprise.

They provide the ability to define and control functions at a more granular business process level and then aggregate those granular functions into more encompassing transactions. For example, rather than performing separate operations to query multiple catalogs, request multiple quotes and submit a purchase order, one could aggregate these transactions to create a single operation to query a set of manufacturers and then buy on specification, price, and availability. This capability offers business and standards the opportunity to converge to a more service focused methodology.

Web Services also offers tools and methods that can substantially automate solution development—reducing the costs and time needed to implement—thus expanding the range of companies that can be directly connected into high speed markets.

When Web Services are combined with industry consortia business level semantics, the value becomes very evident. Together Web Services and these industry standards can simplify the connection and communications of multiple business tiers, even down to unique applications. Such a combination will not only offer enterprise adaptability, it will also enable significant process changes as information is more quickly shared across a supply chain—increasing responsiveness of and visibility into more partners. Web Services and industry standards will enable supply chains to achieve higher levels of automation and responsiveness without having to invest in proprietary infrastructures. Together they can offer a direction to the ever demanding marketplace.

The Web Services Family of Standards

The Web Services framework consists of a modular, extensible stack of XML specifications and standards targeting the emerging infrastructure in which distributed, heterogeneous applications are exposed by different organizations as services on the Internet. These services have their capabilities described and published in a machine readable format.

Two key concepts differentiate Web Services from other approaches: the composability and extensibility of the specifications making up the stack, and the interoperability and portability obtained through standardization efforts. Web Services, by design, do not dictate a particular implementation or system architecture, thereby enabling their use across systems that support the XML standards and specifications making up the framework. They offer a much more automated approach to setup and use through standards compliant tooling. Any party with a compliant implementation can use them to carry out business interactions.

The approach described in a first embodiment herein uses a subset of the Web Services specifications that enable services to be described, interacted with, and composed: WSDL, WS-BPEL, WS-Security, WS-ReliableMessaging, WS-Addressing, WS-Policy, WS-PolicyAttachment, and WS-SecurityPolicy.

The Web Services Description Language (WSDL) provides a standard way to describe the interface supported by a Web Service, its binding to an interaction protocol, and addressing information on where an implementation is deployed. Each WSDL definition consists of an abstract part and a concrete part. The abstract part of WSDL consists of a set of typed messages and a set of portTypes. A portType is simply a named logical grouping of operations. Each operation has a name and defines the input and possible output WSDL message(s) it expects for an interaction. The concrete parts of a WSDL definition consist of bindings that bind portTypes to specific interaction protocols and message formats (ie, HTTP and SOAP). Finally, a port provides the endpoint information (ie, URL) for accessing an implementation of a portType using a certain binding (and can be addressed using WS-Addressing). A set of ports may be grouped as a service.

The Business Process Execution Language for Web Services (BPEL4WS aka WS-BPEL, or simply BPEL) is a workflow language for composing Web Services by providing control semantics around a set of interactions with the services being composed. The business process itself may also be exposed as a Web Service, providing its own WSDL portTypes to its partners.

BPEL processes can be expressed as: executable and abstract. The executable variant contains all the information necessary for a process to be executed by a workflow system. On the other hand, the abstract variant enables one to define interaction protocols or process templates that partners can use to know how to interact with the process and how it will interact with them. Certain information that is considered either private or ungoverned by the business logic can be left out of an abstract process. This includes such items as the initialization of variables or calling private routines.

BPEL processes can invoke and be invoked by one another since a process is just another Web Service with a WSDL definition. BPEL's recursive composition and its use of the same language for defining both executable and abstract processes permit the standardization of business processes at the abstract level, while enabling all the adaptability needed for partners to define their own compliant executables that can call into their private functionality. BPEL also provides fault, event and compensation handling capabilities.

Protocols for carrying out quality of service requirements have been defined for a number of areas related to Web Services. Of these, we highlight security and reliable messaging. WS-Security provides for confidentiality, authorization, and integrity of messages using digital signatures and encryption. WS-ReliableMessaging provides a protocol for reliable message delivery.

In Web Services, quality of service parameters may be defined externally as assertions using WS-Policy and attached to different parts of a WSDL definition using the WS-PolicyAttachment specification. WS-Policy assertions related to WS-Security are defined in the WS-SecurityPolicy specification. WS-Policy assertions related to WS-ReliableMessaging are defined within the WS-ReliableMessaging specification itself.

Using the above set of standards and specifications, an approach for defining and exchanging Business Messages using Web Services will now be described.

A Web Services Approach to Industry Messaging

Our invention relating Web Services approach consists of embodiments relating to: modernization and repackaging of Business Messages and the use of a Web Services runtime stack to support message exchange and handling.

Modernization and repackaging of the Business Messages includes conversion of document definitions from XML DTD to XML Schema for all header documents (Preamble, etc) and business signal documents defined in RNIF (Receipt Acknowledgment, etc) as well as all business action documents defined by each message specification (for example, the documents defined in PIP 3A4, etc). This effort will also address the harmonization of such schema constructs as namespaces and business element reuse. Efforts such as these are already underway at various levels within many standards bodies and are being harmonized and funneled through organizations such as WS-I. Then, for each role defined in the Business Message specification (for example, buyer and seller), a set of WSDL definitions, abstract BPEL processes, and WS-Policy assertions are generated to define the structure of the messages sent and received via Web Services, as well as the handling of those messages for the role. As in the current PIP packaging, a human-readable document should also be included.

Each interacting party in a business interchange would go to a repository and pick up the set of files related to the role it will play in the interaction. This is similar to the downloading of a specification today except the recommended downloads will be fully machine processable by available tooling. Using such tooling, they may then modify or customize the BPEL and other files based on local policy, Partner Profiles and Trading Partner Agreements before deploying them. These new recommended specifications will begin to resolve issues currently being addressed by efforts such as the RosettaNet Trading Partner Profile work.

The corresponding runtime environment consists of a WS-BPEL sub-system to run implementations of the abstract processes, a WS-Security sub-system, a WS-ReliableMessaging sub-system, a non-repudiation sub-system, and a message validation sub-system. The first three sub-systems are part of the Web Services stack and are covered by published specifications. The non-repudiation and message validation sub-systems represent opportunities for standards consortia to address their standardization, or they can be implemented as internal/private processes.

Note that this proposal is expecting support for non-repudiation to be contained within WS-Security. As shown in the later figures, we propose a profile extending Web Services Security to provide Proof of Message Origin and Proof of Message Receipt. This solution would serve the non-repudiation needs of business messaging and handle them appropriately in the middleware layer of a WS-* compliant system.

Define Business Messages Using XML Schema

In creating a Web Services-based business message, one must first create the relevant XML Schema definitions. They may either be converted from existing DTDs or directly defined as some of the consortia have done for ones that are natively Web Services-enabled. This effort will need to be rationalized with those efforts being brought forth by other standards organizations such as WS-I.

Existing schema technology and tools can, add the first level of restrictions directly to the XML Schema definitions. Additional restrictions can then be applied via tooling during subsequent layers of processing. This newer approach, although counterintuitive for a standard, has already been applied by other standards bodies. They leverage the tooling for meeting partner requirements in later stages of processing, rather than imposing a construct within the standard. Note that some of the complex business requirements beyond those covered within schema can be handled by internal sub-systems and applications, as well as addressed by the standard through combined efforts with other standards organizations.

In addition to the action messages defined in the Business Message specification, XML Schema definitions must also be generated for the standard header messages (Preamble, Delivery Header, and Service Header) and business signal messages (Receipt Acknowledgment and Exception) that are currently defined in RNIF.

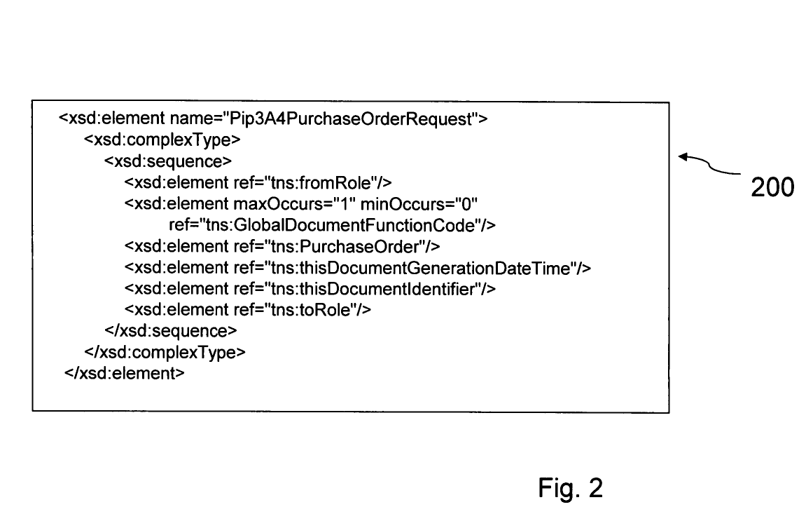

Each Business Message will be formed from a set of XML Schema types, either complex or primitive. FIG. 2 illustrates part of a sample XML Schema 200 for the 3A4 Purchase Order Request action message. This corresponds in Web Services to defining a WSDL message that has parts with the corresponding Schema types. An important decision in the creation of the XML Schema types, therefore, would be reusability. This modularity allows that a Schema type may be used in multiple places in one WSDL message, multiple WSDL messages, and even WSDL messages that are logically tied to multiple business operations. The granularity at which to create these Schema types is therefore an area with some flexibility and choice for each consortium. The optimal choice will depend on a study of business needs across the business process, the similarities between them, and the capabilities of current or near term tooling.

With respect to reusability and interoperability, there is some debate regarding optimal use of XML namespaces. This issue is being prototyped in several standards bodies throughout the market and in WS-I working groups. Participation in these debates and groups will be a requirement for any industry consortium to pace industry directions.

Define Web Services Messages and Operations Using WSDL

The Business Message package will typically contain one WSDL document for each role defined in the interaction. Each WSDL document only includes the abstract section of a WSDL definition, namely the messages, operations, and portTypes. The portType will contain the operations that the given party will expose to the other party. A message exchange for a typical standard message would therefore correspond to the invocation of a Web Services operation from such a portType.

In the case of synchronous actions, one party would provide an input-output WSDL operation that takes the requesting message as input and returns the response message as its output. For asynchronous actions, a message exchange from Trading Partner A to Trading Partner B corresponds to B providing an input-only WSDL operation that can consume that message. If the requirement is for an acknowledgement to be sent back, then in a similar manner A would provide an operation that can consume the acknowledgement.

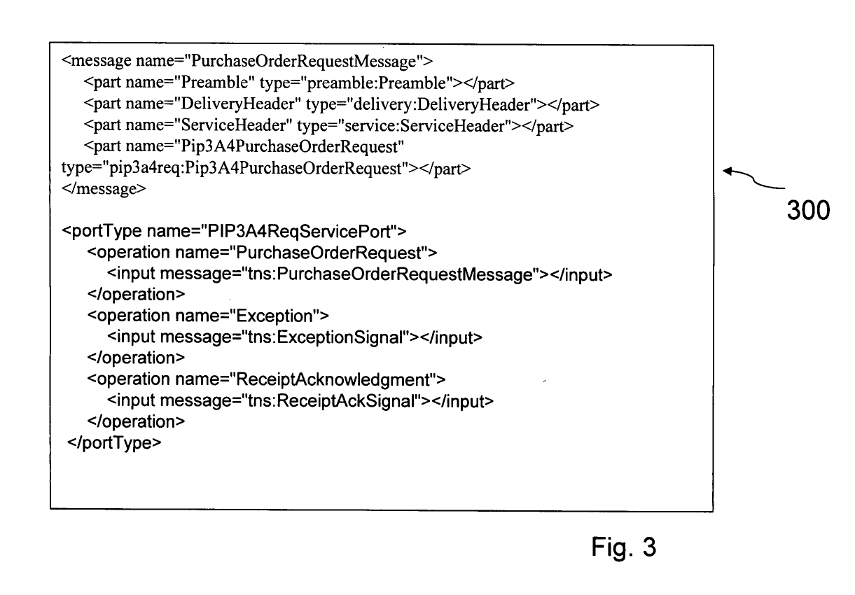

The RosettaNet PIP 3A4 Request Purchase Order incorporates a buyer role and a seller role within its envisioned process. In order for such a buyer to send a purchase order to the seller, the seller must expose a receivePurchaseOrder operation on its portType that consumes a WSDL message containing the PurchaseOrder. FIG. 3 illustrates part of a sample WSDL definition for the 3A4 Purchase Order Request action message 300.

Other consortiums such as OAGIS have included operations such as Get and Show within their specifications and they would also need to mirror this methodology for executing asynchronous processes.

The binding and port information, which specify how and where to call the operations, will not be added until the WSDL definitions are deployed by the given party. Although bindings and ports are out of the scope of the current Business Message specifications, we recommend requiring at least a WS-I compliant SOAP binding.

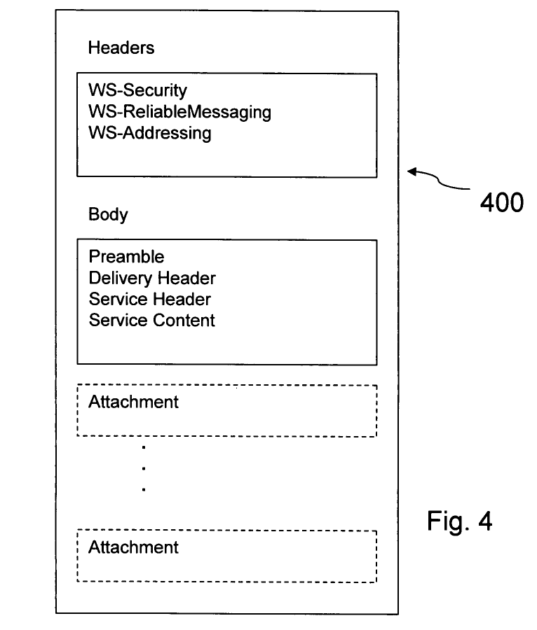

FIG. 4 illustrates an SOAP message structure for a Business Message 400. A SOAP representation of the Business Message would be constructed using the WSDL message definitions. The SOAP headers should contain composable elements for WS-Security, WS-ReliableMessaging, and WS-Addressing to address the functions currently in use with the RNIF today. The SOAP body will contain all elements of the standard Business Message. Keeping all components of the Business Message together allows easier conversion to/from the RNIF 2.0 format by a trading partner or trusted hub and may provide advantages for message processing and archiving. The SOAP body (along with any attachments) will be signed and may be encrypted using WS-Security. This will provide for message origin authentication, integrity, confidentiality, non-repudiation and message freshness (via Timestamp) of the Business Message.

It is proposed that all the resulting specifications strive for maximum interoperability by conforming to the profiles and specifications being offered through WS-I. At a minimum compliance with Basic Profile 1.1—Final Specification, Simple SOAP Binding Profile 1.0—Final Specification and Attachments Profile 1.0—Final Specification be part of the design of any specification or solution. It is also expected that the specifications from the Basic Security Profile Working Group Draft and the Profile Conformance Framework WG Draft be incorporated based on the timing along with any additional support for interoperability that may emerge from WS-I.

Define Web Services Message Handling Using BPEL

A typical specification identifies not only the messages that will be exchanged by the interacting parties, it also lists or infers the sequence in which those messages are exchanged along with any timing constraints. Since the de facto specification for representing such business processes in a Web Services environment is WS-BPEL, the Business Message package will include one abstract BPEL process per interacting party (role) and each will include the business logic concerning the associated business role.

Note that the BPEL processes specified in the standard will be abstract BPEL processes which do not define links to a business' back-end system or show how the partner is supposed to process the documents it exchanges. Another possible set of files to include are default executable BPEL files for each party. These would include an implementation of the abstract BPEL files that simply forward messages from and to the back-end systems of the partners as long as they are exposed as Web Services complying with certain specified portTypes.

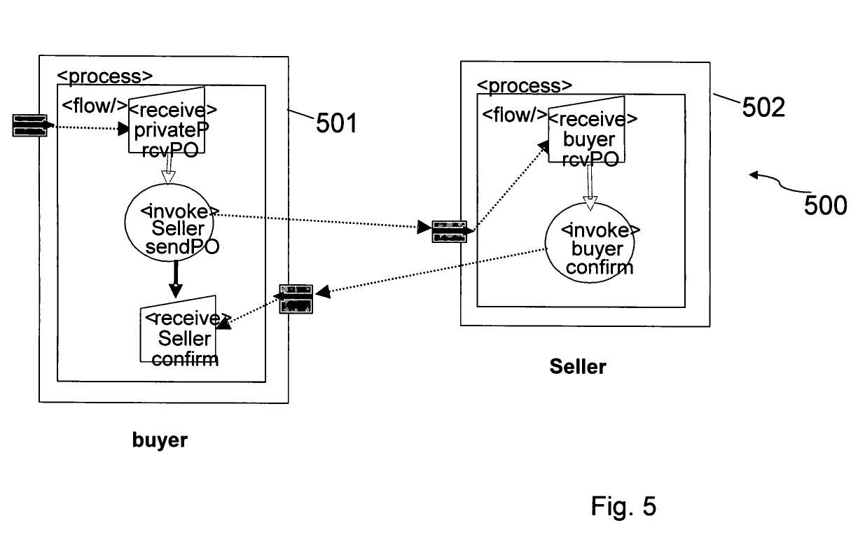

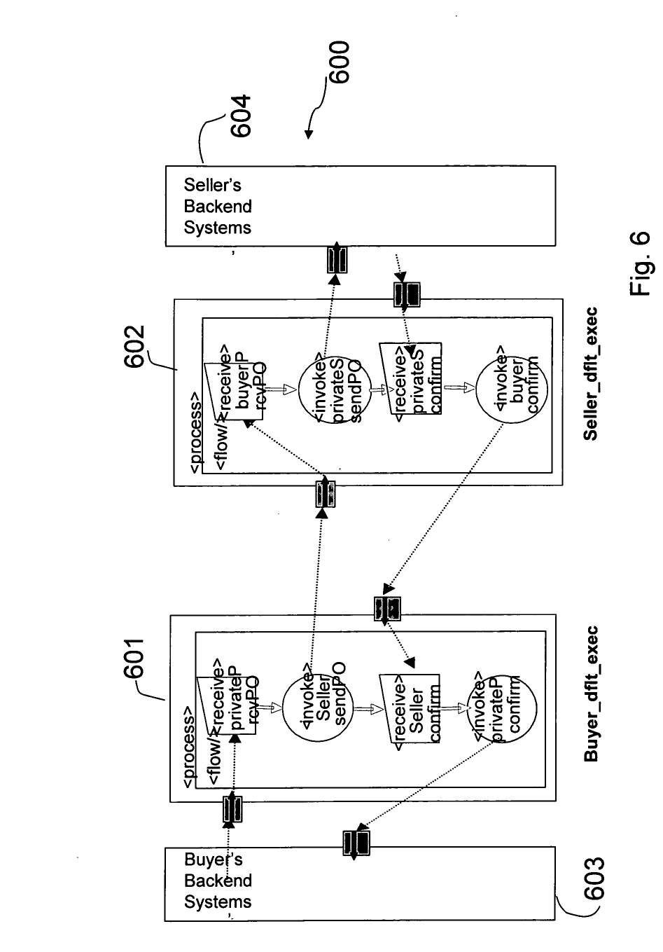

With reference to FIG. 5, is an Abstract BPEL processes for each participant for submitting a PO. The rectangles with arrows indicate portTypes with operations. Timeouts and fault handlers are not shown. This example is similar to RosettaNet PIP 3A4, for simplicity the acknowledgements, faults, and timeouts have been removed from the processes. This level of detail corresponds to the business view, which can be further refined by adding the acknowledgement, faults and timeouts to create processes. FIG. 6 show an Executable BPEL processes that comply with the abstract ones above and interacts with the back-ends. Timeouts, validation and fault handlers are not shown for simplicity. FIG. 5 shows the abstract processes 500 provided to a buyer 501 and a seller 502. FIG. 6 shows default executable BPEL processes that may be generated from the abstract ones. Processes 601 and 602 interact with the back-ends 603 and 604, respectively, at runtime.

BPEL provides the ability to manage message instances to ensure that messages corresponding to a specific business process instance do not accidentally get routed to a different one. It provides constructs to implement timing constraints and fault handling. BPEL processes can be designed to incorporate message validation and retries along with handling of duplicate, out of order, and post-completion messages.

A more in-depth look at how BPEL can be used in the Web Services solution is described below.

Define Web Services Quality of Service Using Policy Files

Quality of service requirements for Web Services is usually either defined within the given Web Services specification or via another closely coordinated specification. For our approach, we use policy assertions defined by the specifications to cover the various business operation parameters given in specifications. The policy assertions are based on the WS-Policy specification and attached to the appropriate WSDL operations per the WS-PolicyAttachment specification.

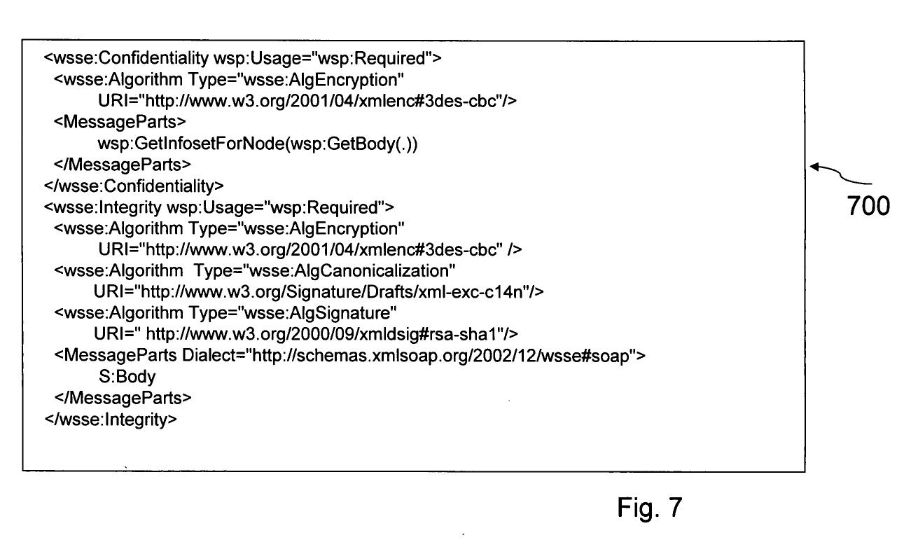

In particular, information related to security (authentication, integrity and confidentiality) will be specified using assertions defined in the WS-SecurityPolicy specification. Information related to reliable message delivery will also be included in the policy assertions defined in the WS-ReliableMessaging specification. FIG. 7 illustrates part of a sample showing WS-Security assertions 700. Note that an assertion for “maximum number of retries” for message delivery is not yet defined in the WS-ReliableMessaging specification but we are hopeful that it will be added in the near future.

Many of the remaining business operations parameters given in specification are built into the BPEL process. Time to acknowledge with a receipt signal, time to respond to an action, overall time to perform, and whether or not the time to respond to an action is included in the time to perform are all built into the timer functions defined in the BPEL process. Whether or not secure transport (SSL) is required is automatically taken care of by specifying HTTPS as the protocol in the URL for an operation's target endpoint.

However, there are two operational parameters that are not covered by any Web Services specification:

Is authorization required?

Is non-repudiation required?

A custom policy assertion can be created for “Is authorization required” and consumed by a validation sub-system. For non-repudiation, the approach described below, could easily make use of WS-Policy assertions—although it does not defined any as yet. Section 6, Next Steps, cover this topic in more detail.

The Web Services Runtime Environment

Business Messaging Web Services approach is capable of the incorporation of a Web Services runtime stack during message transmission to include:

WS-BPEL

WS-Security

WS-ReliableMessaging

WS-Addressing

WS-Policy

WS-PolicyAttachment

WS-SecurityPolicy

Initially, only seven of the Web Service specifications are being considered. However, additional embodiments may include other web services.

The sub-system implementing WS-BPEL is responsible for running executable BPEL processes and maintaining their state. When receiving a message, the sub-system uses correlation sets to know whether to invoke a new process or route the message to a process that is already running. Note that WS-Policy assertions can be attached to BPEL constructs.

The sub-system implementing WS-Security performs signature and encryption processing for outbound messages and signature validation and decryption processing for inbound messages. For outbound messages, the sub-system should pick up processing properties and quality of service requirements from WS-Policy assertions associated with the WSDL operation. Inbound message processing should be automatic based on the presence of the WS-Security SOAP headers. Once non-repudiation support is added into WS-Security, it would also be used to handle sending back the requestor's signature and message digest with the business level acknowledgment message.

The sub-system implementing WS-ReliableMessaging provides reliable message transmission. It is only needed when transmitting or receiving specified action messages (per RNIF specification). For outbound messages, the sub-system is responsible for sending the message to the specified receiving party as many times as necessary until either an acknowledgment is received or a maximum retry threshold, if any, is reached. Processing properties and quality of service requirements should be picked up from WS-Policy assertions associated with the WSDL operation. For inbound messages, the sub-system is responsible for receiving the message and sending an acknowledgment back to the sender's WS-ReliableMessaging sub-system.

The WS-Addressing specification is either a current or future prerequisite for some of the other specifications (ie, WS-ReliableMessaging). In addition, addressing elements could be used by a BPEL process to allow Web Service target endpoints to be provided dynamically at runtime for each instance rather than only once at deployment for all instances.

The WS-Policy family of specifications is handled by a policy framework in a Web Services based system that can compute effective policies from the policy attachments, check their compatibility with the system's capabilities and the available services, and configure its subsystems to implement the relevant assertions (WS-Security and WS-ReliableMessaging sub-systems initially). Further embodiments could include a specification for the dynamic exchange of policy files (WS-MetadataExchange). Current embodiments could include policy files that may be exchanged manually or via some other mechanism.

The BPEL Solution In Depth

Basic BPEL

For an abstract BPEL process, we divide the entire definition into three parts: the definition of the parties the process will interact with, the definition of process variables to hold message values, and the definition of the control logic corresponding to the process flow. In BPEL, control logic is defined around a set of interaction activities than can invoke operations on other services and process invocations from other services. These activities are invoke, receive and reply. The first invokes operations on a partner's portType, and the last two receive the input to an operation offered by the process and send back a response message if one is required.

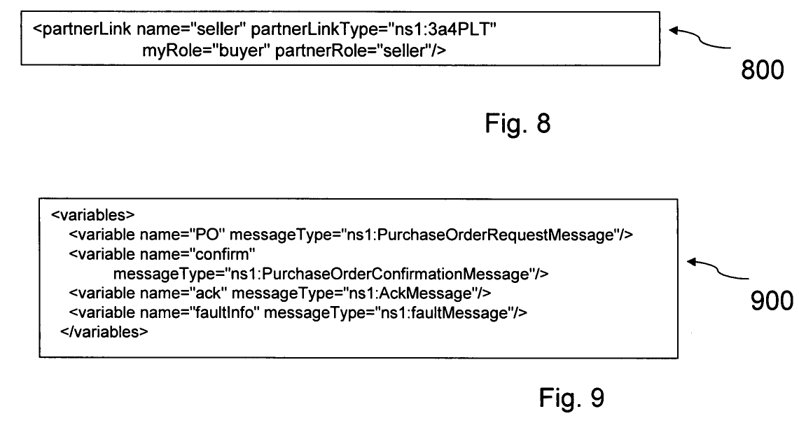

BPEL provides a set of partnerLinks to define the connections to the parties the process will interact with. PartnerLinks are instances of the partnerLinkTypes WSDL extension elements that must be added to the WSDL definitions. FIG. 8 illustrates an Example of a BPEL partnerLink definition 800. Each BPEL process created for a Business Message will contain one partnerLink for each instance of the partnerLinkType for the message. For simplicity the following examples use the RosettaNet 3A4 PIP Request Purchase Order for illustration, but CIDX, OAGIS or PIDX corresponding messages would be handled in a similar fashion. The partnerLink will specify which role the process plays and which role the partner will play.

At least one more partnerLink 800 (and partnerLinkType) needs to be created. BPEL requires that a business process provides at least one receive activity that can create an instance of the business process. The process that sends the first message will need to receive an external signal to start it. The other process will use the activity that receives the first message as its instance-creating receive. For the first process, therefore, we need to define a partnerLink to the arbitrary “starter” of the process.

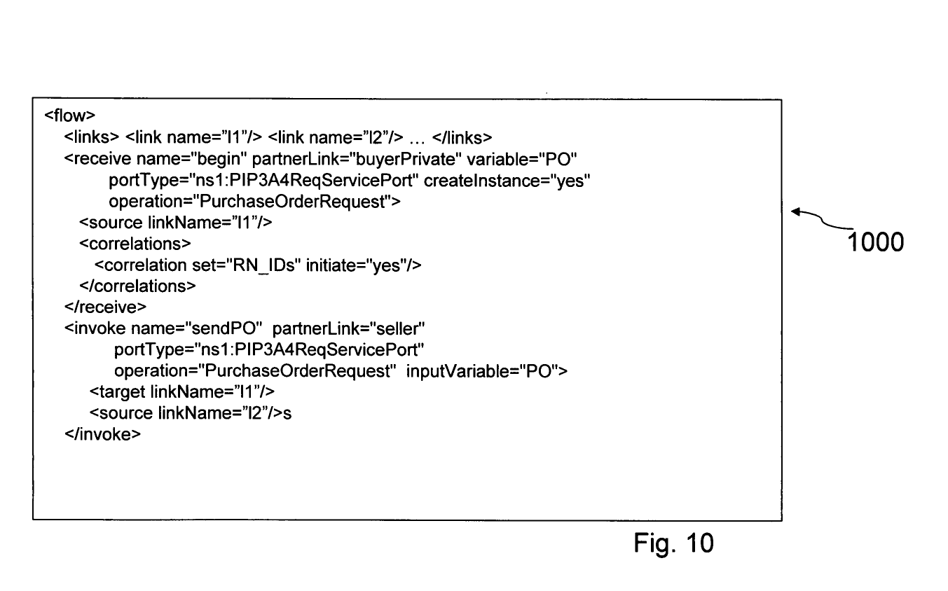

FIG. 9 illustrates an example of a BPEL variable definition 900. BPEL variables are created to hold the messages the process will exchange. They are typed using the WSDL messages of the operations through which the messages will be exchanged. In abstract BPEL processes, a variable can be initiated with an opaque value. The opaque assignment signifies that compliant implementations must copy a value into the appropriate variable in any way they see fit.

BPEL enables the definition of arbitrarily complex control constructs using structured activities such as sequence and flow that include activities within them and dictate the order in which the included activities will execute. The appropriate top-level construct should be chosen when mapping to BPEL. In our experience, most Business Message specifications specify a straight sequencing of the message exchanges. Therefore a sequence activity or a simple flow with links may be chosen. To include forking in case of validation and the concurrency of receiving the acknowledgment or the second action message in a multiple action process, we start with a flow activity.

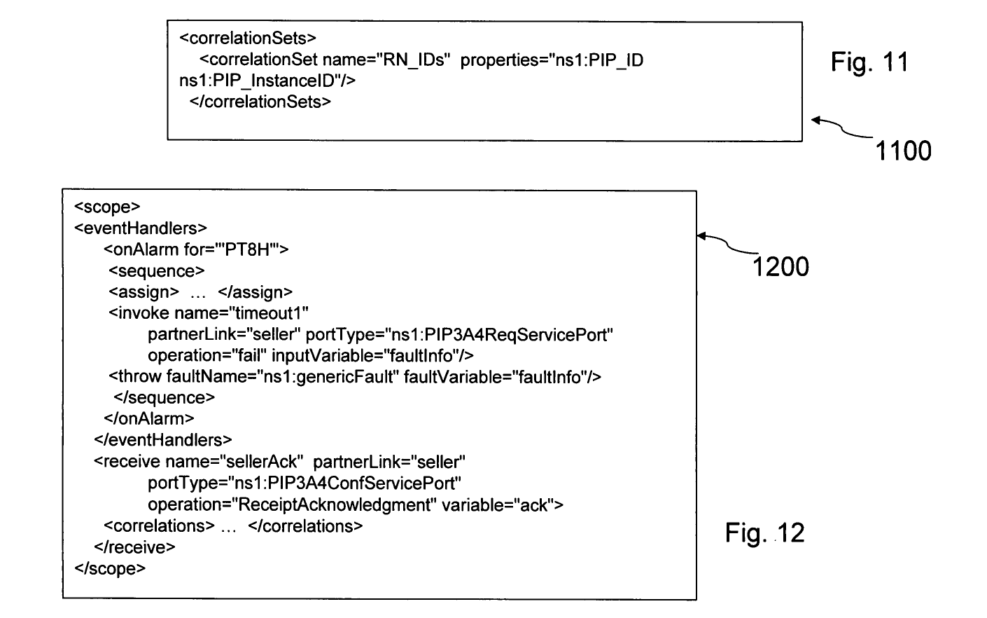

A process receiving a message corresponds to either a receive activity or the completion of an invoke activity. The invoke activity blocks until the response returns. A process sending a message corresponds to either a reply or an invoke activity. If the message is the response to a call to one of the process's request-response synchronous operations, then a reply is used. Otherwise, an invoke is used. These activities are used to choreograph the order of interactions in each business process. Note that the BPEL processes being created are mirror images of each other, such that an invoke in one process corresponds to a receive on the other. Given the above information regarding the partners, the variables, and the operations provided, one can easily map from the Business Message specification to the BPEL receive/invoke/reply activities in a sequence activity. Next, one can add the additional information such as timeouts and failure notifications. FIG. 10 illustrates an example BPEL control logic 1000 as used for web services.

Managing Message Instances

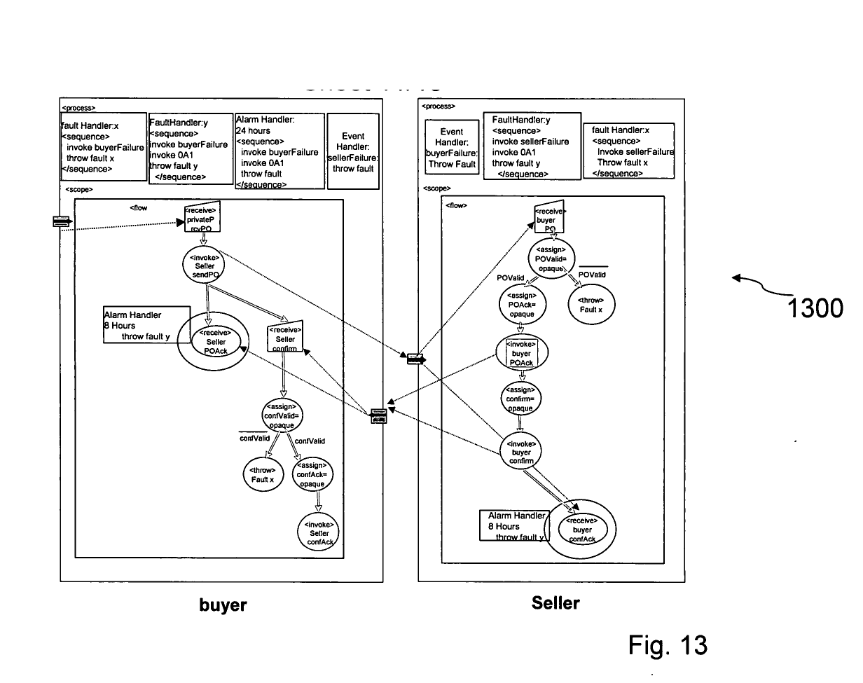

In BPEL, a message that comes to a receive activity with a createInstance=“yes” attribute will create an instance of the BPEL process, corresponding to an instance of the business process. Subsequent messages targeted at that instance will be routed to the same BPEL process instance. BPEL defines a correlation mechanism to enable it to maintain conversations over the lifetime of a process instance. FIG. 11 illustrates an example of an BPEL correlation set 1100. Named, typed properties are defined and aliased to different parts of the WSDL messages used by the process. These properties may then be grouped into correlation sets and attached onto the interaction activities.

Using correlation enables one to guarantee that messages corresponding to a specific business process instance do not accidentally get routed to a different one, while still enabling multiple instances to be run concurrently.

In the case of mapping RosettaNet PIPs to Web Services in the accompanying example, we propose using the Message Code and the Message Instance ID as values to correlate on. In order to ensure uniqueness, it is possible that information about the trading partner will also need to be included in the correlation set.

Timeouts

BPEL contains constructs for the definition of delays, alarms and fault handling that can be used in order to represent the timing constraints on certain aspects of the process, as well as to specify the detection and notification of failures.

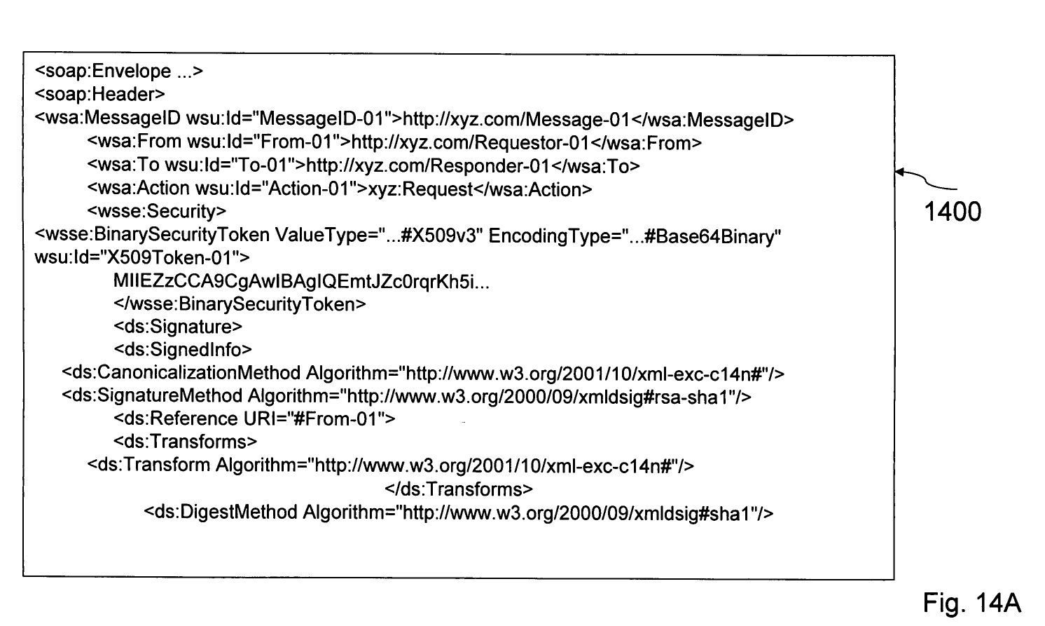

To specify that a message must be received within a certain time limit, one surrounds the receive activity in a scope with an alarm handler. The activity in the alarm handler will be executed if the alarm goes off. However, if the receive completes before the alarm goes off, then the alarm will be disabled and processing will continue regularly. This approach is used to create the BPEL behavior specified in the timing constraints of the process. FIG. 12 illustrates an example BPEL timer logic 1200 being used for web services.

In the case of this example, if no message is received in the allocated time, an operation should be invoked to inform the other party of the failure, and a fault should be thrown in the process itself. If not caught, such a fault would terminate a process. Throwing a fault instead of using <terminate> to terminate the process enables compliant implementations of the abstract process to catch such a fault and perform any necessary clean-up needed, before termination. If this is the result of a timeout then the specification requires that an error message be invoked (0A1), which, for example, the owner of the process may want to send as a failure message to their own back-end systems. The other standards have similar message specifications.

Retries

Retries may be modeled in BPEL using a combination of while loops, a pick activity that can trigger based on either a message or a timeout, and links. On the receiving process, a scope that waits for max time would be created to handle duplicate messages and resend the acknowledgements as required. However, this clutters the business logic with an attribute that really belongs either to the lower level networking layer, if it is regarding resending one message, or to a higher level workflow management system layer if it is regarding restarting the entire process or subsections of a process.

In one embodiment, the WS-ReliableMessaging sub-system will perform all necessary retries to ensure reliable message delivery.

Validating Messages

Web Services require that transported messages conform to the declared schemas. As such, Web Services implementations perform schema type checking on the incoming messages before they reach the underlying service implementations. These checks represent the first minimal level of business validation. In such cases there is no need for a representation of the validation in the business process.

There are situations where schema checking is not enough and a business exchange requires that further dictionary or business relationship validation be performed. In such cases, one may represent this in the BPEL process by defining an assign activity that places an opaque token into a Boolean variable. The Boolean variable is then checked. If it evaluates to false then a fault is thrown. This could be used to indicate to compliant implementations (possibly executable BPEL processes) that they must perform the additional check and place its result in the variable.

Note that if links are used, then the “suppressJoinFailure” should be set to “yes” for this setup. Otherwise, a link with a fault condition could terminate the entire process instead of the expected behavior of simply skipping the target activity.

Faults

In addition to the fault defined due to timeouts, business signals set to signal failure are also modeled by invoking an operation provided by the trading partner that can consume an error message. On the receiving side, the BPEL process would contain an event handler that can receive such exception messages from its partner(s). The event handler's activity would contain the reaction that the process is supposed to have upon failure notification.

Another kind of fault notification is present in some specifications. An example is using the 0A1 Notification of Failure PIP or the Confirmation BOD in OAGIS. The general guideline is that this type of message will be used if it is possible that the partner is to be notified of a process that is no longer executing. Since such messages are unique in their own right, they will have their own WSDL and BPEL files and a corresponding partnerLink in the BPEL process. If the original process needs to initiate a notification of failure, it would invoke the operation offered by that message's portType. If BPEL executable processes are used in combination with the failure messages, then one must provide some way to propagate the fault to the process in question. How this is done is left out of RNIF and we therefore relegate it to the private business logic/systems.

Note that RNIF recommends that 0A1 PIP messages be transmitted via a different channel than regular messages. E-mail or perhaps telephone/pager would be possible alternatives. In either case, an administrator on the receiving side will need to evaluate the failure condition and act appropriately. Enterprise level workflow management systems usually provide administrative capabilities to monitor and manage running processes, which can be used to terminate the corresponding processes. Alternatively, if one uses a lightweight system, the executable BPEL process could provide an event handler for a local administrator to terminate the process.

Duplicate, Out-of-Order, and Post-Completion Messages

The message choreography and handling requirements specified by Business Messages and incorporated within the RNIF or other frameworks that use asynchronous messaging can sometimes result in receiving duplicate messages, receiving messages out of expected order, and possibly receiving messages after the associated process has completed. RNIF does not address messages beyond a completed process nor does it address multiple PIPs running concurrently, which can natively be handled by executable BPEL.

A duplicate action message may be generated if the sending party does not receive the associated receipt acknowledgment/exception signal message from the intended receiving party within the required time limit. With reliable message delivery now handled by the WS-ReliableMessaging sub-system, using a delivery assurance of “Exactly Once” should eliminate duplicate messages getting through to the BPEL process.

Given the nature of asynchronous messaging and parallel processing, it is possible that a response action message may arrive before the receipt acknowledgment signal message associated with the initial action message. This situation is handled by the BPEL process via a flow structure that allows for concurrent behavior, or a forking of the process.

With the current message handling process described by RNIF, there are at least two scenarios where a message may arrive after the process has completed—one for a single-action message and one for a dual-action. For example, in the scenario for a single-action message, Trading Partner A sends an action message to Trading Partner B and then waits for the receipt acknowledgment/exception signal message. If Trading Partner B received the action message successfully, it will send the receipt acknowledgment back to Trading Partner A, process the action, and then end. If Trading Partner A never receives the receipt acknowledgment and Trading Partner B's process ends before A sends the action message again, then there will be no process running at B to consume the duplicate action message. Fortunately, since this is a duplicate message situation, the message will be stopped by the WS-ReliableMessaging sub-system as described above.

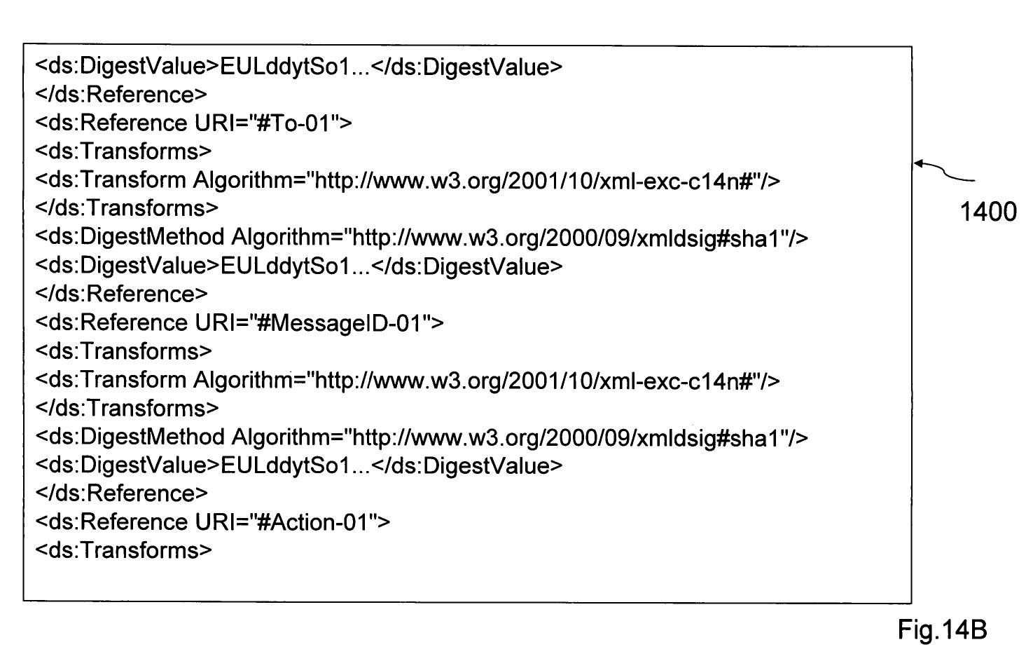

With all the pieces in place, we now depict an example abstract process in FIG. 13 below again using the PIP 3A4 Purchase Order Request as the example. FIG. 13 illustrates example BPEL abstract processes for PIP 3A4 Purchase Order request 1300.

Default Executable BPEL Processes

It is possible to derive default executable BPEL processes to be included in the Web Services Business Messaging package. For each abstract process, a default executable can be created with the assumption that the back-end systems of the party that wants to use them complies with the provided WSDL portType. It is important to note that this is an extra capability that provides one possible execution variant. The parties may choose to implement the abstract BPELs using other means and are not forced to use executable BPEL.

BPEL itself does not formally specify what it means for an executable process to comply with an abstract one. The restriction we follow in such creation is that the projection of each executable process relating to the partner defined in the Business Message specification is not violated. In other words, other partners can be added and interactions with them interleaved in the process definition. It is disallowed, however, to modify existing interactions with any partners already defined in the abstract process.

The executable BPEL will add all necessary logic required by that partner to comply with and execute its end of the multi-party interaction. In particular, this includes interacting with the company's back-end systems for such functionality as procurement and inventory. The company may decide to either expose each of its subsystems as Web Services or provide one Web Service that overlays its IT infrastructure. In either case, the executable process can interact with them.

One approach for deriving these processes is to add to each a partnerLink representing the company's systems and forwarding all incoming messages to those. On the other hand, any variables that are opaquely assigned in the abstract process are then initialized either as the result of the response to an invoke or by a receive activity that receives a messages containing the values of those variables from the back-end systems. In one demo set-up, the back-end systems consisted of forms that take human input, Web Services clients, and services that share access to data in the file system.

A global fault handler is also added that notifies the back-end systems of any faults raised and not handled that could cause the process to terminate.

The implementations of the back-end systems are not part of the executable process. It only cares that it can forward the incoming messages to them and that it can get any data it needs from them. The main thing to take away is that this approach presents only one way to create a compliant implementation. Any additional or specialized adaptation steps necessary for interacting with a company's back-end systems may be used and any allowed customization to the process may be performed.

Non-Repudiation for Web Services Messages

Overview

Disputes may arise with a business transaction with respect to the agreement between the involved parties. In order to protect the interests of these parties, some evidence of the agreement must be generated and preserved in the event that a third party must be called in to resolve the dispute. In the case of transactions initiated via Web Service messages, this evidence must consist of Proof of Message Origin, Proof of Message Receipt and Original Message content.

Proof of Message Origin

PMO may consist of a digital signature over original message content. Potentially this could be a digital signature, generated by the Initial Sender and provided to the Ultimate Receiver, which envelopes the entire original message. However, for Web Service messages this method is unacceptable due to the possibility that intermediaries may partially process the message, altering some subset of the content, en route from the Initial Sender to the Ultimate Receiver. To allow for this possibility the subset of the message content could be signed by the Initial Sender and targeted at the Ultimate Receiver and should not include the subset of the content that intermediaries could alter.

The Initial Sender should create a Web Service Security conformant XML Signature which binds together and provides origin authentication for the following message elements:

the <SOAP:Body> element containing the application specific message data (SOAP 1.2),

<wsa:MessageID> header block element which uniquely identifies the message (WS-Addressing),

<wsa:From> header block element which identifies the Initial Sender (WS-Addressing),

<wsa:to> header block element which identifies the intended Ultimate Receiver (WS-Addressing),

an <wsa:Action> header block which identifies the intended message semantics (WS-Addressing),

<wsse:KeyInfo> element which identifies the Signer's (AKA Initial Sender's) Security Token (XML Signature),

any additional header block elements targeted to the Ultimate Receiver.

The Initial Sender's signature should not refer to the outer SOAP Header element since doing so would prevent insertion and removal of individual header block elements not targeted to the Ultimate Receiver. It is noted that the Initial Sender, Ultimate Receiver, and/or some Third Party could store the signed message content for dispute resolution purposes.

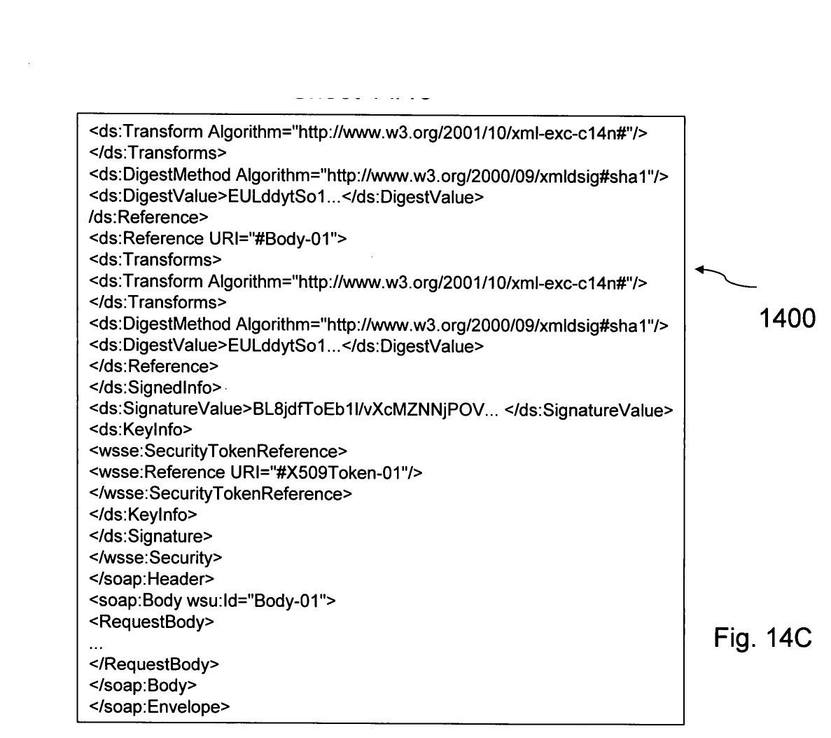

An example of a message 1400 with Proof of Message Origin is shown in FIGS. 14A-14C.

Proof of Message Receipt

PMO provides the mechanism for resolving disputes related to message content. However, there remains the possibility that an Ultimate Receiver may claim to have never received a message at all. PMR provides a solution to this problem.

PMR may consist of a digital signature over the received message content. Potentially this could be a digital signature, generated by the Ultimate Receiver and provided to the Initial Sender, enveloping the entire original message. However, for Web Service messages this method is unacceptable due to the possibility that intermediaries may partially process the message, altering some subset of the content, en route from the Ultimate Receiver to the Initial Sender. To allow for this possibility the subset of the message content signed by the Ultimate Receiver should match the subset of the message content signed by the Initial Sender and targeted at the Ultimate Receiver. The Ultimate Receiver, Initial Sender, and/or some Third Party may store the signed PMR for dispute resolution purposes.

The Ultimate Receiver may verify the PMO before generating a PMR. Since the Initial Sender provided a PMO in the form of a <ds:SignatureValue> over the information targeted at the Ultimate Receiver, the PMR could be efficiently generated by having the Ultimate Receiver sign that <ds:SignatureValue>. In order to provide the functionality a new element <ReceiptAcknowledgement> is defined.

The <ReceiptAcknowledgement> element contains:

a <wsa:RelatesTo> element which identifies the <wsa:MessageID> from the original message and specifies <ReceiptAcknowledgement> as the <wsa:RelationshipType> (WS-Addressing),

a <ds:SignatureValue> element which provides the verified <ds:SignatureValue> from the original message (XML Signature).

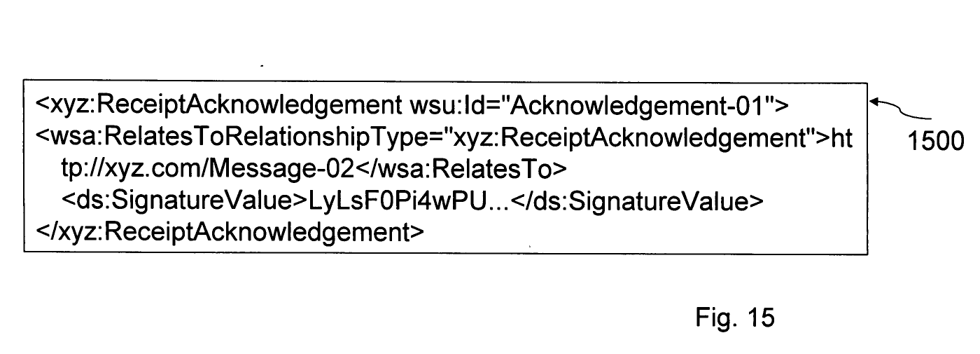

FIG. 15 illustrates a <ReceiptAcknowledgement> element 1500.

Delivery of Proof of Message Receipt

In some cases messages are sent which result in immediate synchronous responses and in other cases responses may be delivered asynchronously. Therefore, it's desirable to provide a mechanism for delivery of the <ReceiptAcknowledgement> together with the response or separately.

In cases where the <ReceiptAcknowledgement> should be delivered with the response the <ReceiptAcknowledgement> may be provided as a signed message header block element as follows:

<soap:Envelope ...>

<soap:Header>

| <wsa:From wsu:Id=“From-02”>http://xyz.com/Responder-01</wsa:From> | |
|---|---|
| <wsa:To wsu:Id=“To-02”>http://xyz.com/Requestor-01</wsa:To> | |
| <wsa:MessageID | wsu:Id=“MessageID-02”>http://xyz.com/Message- |

02</wsa:MessageID>

<wsa:RelatesTo

RelationshipType=“xyz:AcknowledgementMessage”>http://xyz.com/Message-
01</wsa:RelatesTo>

<xyz:ReceiptAcknowledgement wsu:Id=“ReceiptAcknowledgement-01”>

<wsa:RelatesTo

RelationshipType=“xyz:ReceiptAcknowledgement”>http://xyz.com/Message-
01</wsa:RelatesTo>

<ds:SignatureValue>LyLsF0Pi4wPU...</ds:SignatureValue>

</xyz:ReceiptAcknowledgement>
<wsse:Security>

| | |
|---|---|
| <wsse:BinarySecurityToken | ValueType=“...#X509v3” |

EncodingType=“...#Base64Binary” wsu:Id=“X509Token-02”>

MIIEZzCCA9CgAwIBAgIQEmtJZc0rqrKh5i...

</wsse:BinarySecurityToken>
<ds:Signature>

<ds:SignedInfo>

<ds:CanonicalizationMethod

Algorithm=“http://www.w3.org/2001/10/xml-exc-c14n#”/>

<ds:SignatureMethod

Algorithm=“http://www.w3.org/2000/09/xmldsig#rsa-sha1”/>

<ds:Reference URI=“#From-02”>

<ds:Transforms>

| | |
|---|---|
| <ds:Transform | Algorithm=“http://www.w3.org/2001/10/xml- |

exc-c14n#”/>

</ds:Transforms>
<ds:DigestMethod

Algorithm=“http://www.w3.org/2000/09/xmldsig#sha1”/>

<ds:DigestValue>EULddytSo1...</ds:DigestValue>

</ds:Reference>
<ds:Reference URI=“#To-02”>

<ds:Transforms>

| | |
|---|---|
| <ds:Transform | Algorithm=“http://www.w3.org/2001/10/xml- |

exc-c14n#”/>

</ds:Transforms>
<ds:DigestMethod

Algorithm=“http://www.w3.org/2000/09/xmldsig#sha1”/>

<ds:DigestValue>EULddytSo1...</ds:DigestValue>

</ds:Reference>
<ds:Reference URI=“#MessageID-02”>

<ds:Transforms>

| | |
|---|---|
| <ds:Transform | Algorithm=“http://www.w3.org/2001/10/xml- |

exc-c14n#”/>

</ds:Transforms>
<ds:DigestMethod

Algorithm=“http://www.w3.org/2000/09/xmldsig#sha1”/>

<ds:DigestValue>EULddytSo1...</ds:DigestValue>

</ds:Reference>
<ds:Reference URI=“#ReceiptAcknowledgement-01”>

<ds:Transforms>

| | |
|---|---|
| <ds:Transform | Algorithm=“http://www.w3.org/2001/10/xml- |

exc-c14n#”/>

</ds:Transforms>
<ds:DigestMethod

Algorithm=“http://www.w3.org/2000/09/xmldsig#sha1”/>

<ds:DigestValue>EULddytSo1...</ds:DigestValue>

</ds:Reference>
<ds:Reference URI=“#Body-02”>

<ds:Transforms>

| | |
|---|---|
| <ds:Transform | Algorithm=“http://www.w3.org/2001/10/xml- |

exc-c14n#”/>

</ds:Transforms>
<ds:DigestMethod

Algorithm=“http://www.w3.org/2000/09/xmldsig#sha1”/>

<ds:DigestValue>EULddytSo1...</ds:DigestValue>

</ds:Reference>

</ds:SignedInfo>
<ds:SignatureValue>BL8jdfToEb1I/vXcMZNNjPOV...

</ds:SignatureValue>

<ds:KeyInfo>

<wsse:SecurityTokenReference>

<wsse:Reference URI=“#X509Token-02”/>

</wsse:SecurityTokenReference>

</ds:KeyInfo>

</ds:Signature>

</wsse:Security>

</soap:Header>
<soap:Body wsu:Id=“Body-02”>

<ResponseBody>

...

</ResponseBody>

</soap:Body>

</soap:Envelope>

In cases where the <ReceiptAcknowledgement> is delivered separately, it may be provided as a signed Body element as follows:

<soap:Envelope ...>

<soap:Header>

| <wsa:From wsu:Id=“From-02”>http://xyz.com/Responder-01</wsa:From> | |
|---|---|
| <wsa:To wsu:Id=“To-02”>http://xyz.com/Requestor-01</wsa:To> | |
| <wsa:MessageID | wsu:Id=“MessageID-02”>http://xyz.com/Message- |

02</wsa:MessageID>

<wsa:RelatesTo

RelationshipType=“xyz:AcknowledgementMessage”>http://xyz.com/Message-
01</wsa:RelatesTo>

<wsse:Security>

| | |
|---|---|
| <wsse:BinarySecurityToken | ValueType=“...#X509v3” |

EncodingType=“...#Base64Binary” wsu:Id=“X509Token-02”>

MIIEZzCCA9CgAwIBAgIQEmtJZc0rqrKh5i...

</wsse:BinarySecurityToken>
<ds:Signature>

<ds:SignedInfo>

<ds:CanonicalizationMethod

Algorithm=“http://www.w3.org/2001/10/xml-exc-c14n#”/>

<ds:SignatureMethod

Algorithm=“http://www.w3.org/2000/09/xmldsig#rsa-sha1”/>

<ds:Reference URI=“#From-02”>

<ds:Transforms>

| | |
|---|---|
| <ds:Transform | Algorithm=“http://www.w3.org/2001/10/xml- |

exc-c14n#”/>

</ds:Transforms>
<ds:DigestMethod

Algorithm=“http://www.w3.org/2000/09/xmldsig#sha1”/>

<ds:DigestValue>EULddytSo1...</ds:DigestValue>

</ds:Reference>
<ds:Reference URI=“#To-02”>

<ds:Transforms>

| | |
|---|---|
| <ds:Transform | Algorithm=“http://www.w3.org/2001/10/xml- |

exc-c14n#”/>

</ds:Trasforms>
<ds:DigestMethod

Algorithm=“http://www.w3.org/2000/09/xmldsig#sha1”/>

<ds:DigestValue>EULddytSo1...</ds:DigestValue>

</ds:Reference>
<ds:Reference URI=“#MessageID-02”>

<ds:Transforms>

| | |
|---|---|
| <ds:Transform | Algorithm=“http://www.w3.org/2001/10/xml- |

exc-c14n#”/>

</ds:Transforms>
<ds:DigestMethod

Algorithm=“http://www.w3.org/2000/09/xmldsig#sha1”/>

<ds:DigestValue>EULddytSo1...</ds:DigestValue>

</ds:Reference>
<ds:Reference URI=“#Body-02”>

<ds:Transforms>

| | |
|---|---|
| <ds:Transform | Algorithm=“http://www.w3.org/2001/10/xml- |

exc-c14n#”/>

</ds:Transforms>
<ds:DigestMethod

Algorithm=“http://www.w3.org/2000/09/xmldsig#sha1”/>

<ds:DigestValue>EULddytSo1...</ds:DigestValue>

</ds:Reference>

</ds:SignedInfo>
<ds:SignatureValue>BL8jdfToEb1I/vXcMZNNjPOV...

</ds:SignatureValue>

<ds:KeyInfo>

<wsse:SecurityTokenReference>

<wsse:Reference URI=“#X509Token-02”/>

</wsse:SecurityTokenReference>

</ds:KeyInfo>

</ds:Signature>

</wsse:Security>

</soap:Header>
<soap:Body wsu:Id=“Body-02”>

<xyz:Acknowledgement>

<wsa:RelatesTo

RelationshipType=“xyz:Acknowledgement”>http://xyz.com/Message-
01</wsa:RelatesTo>

<ds:SignatureValue>LyLsF0Pi4wPU...</ds:SignatureValue>

</xyz:Acknowledgement>

</soap:Body>

</soap:Envelope>

Next Steps

The invention represents just a few possible embodiments for Web Services for Business Messaging. Some functionality in some of the specifications that did not have a Web Services equivalent at this time were identified with some areas left open additional modifications.

Non-repudiation is an important piece for which a Web Services solution is just emerging but still awaits completion and standardization. Non-repudiation is a requirement for most legally committed business message handling and as such a necessity for business transactions. Non-repudiation support is best handled by using the proposed additions to WS-Security described below. However, several other approaches may be taken.

The abstract BPEL process can be defined to point to a presumed internal process that would then be implemented by the interacting parties as desired—thus permitting unique business relationships to undertake their own level of non-repudiation and relieving the burden from processes where it is not required.

Individual participants can address their own internal business controls behind the WSDL and, as needed, expose their requirements in the WS-Policy layer.

The solution to mandate that the application middleware provide a sub-system for non-repudiation can be viewed as sidestepping the issue, but it has a better chance of success in the short term while the WS-Security updates are made. Interoperability with other non-repudiation sub-systems is not necessarily required, depending on the goals and complexity of the solution and not all business messaging requires such due diligence. In an embodiment of the present invention non-repudiation may provided by the middleware and offered in the standard as an optional process invoked by the participants, with the recommendation to moving to the WS-Security support once that becomes available.

Some processing steps specified by RNIF are very specific to processing RosettaNet based messages and are not covered by the Web Services stack. In such cases where functionality is domain or consortium specific, one has the option of either defining domain-specific extensions to the given specifications or defining Web Services interfaces for possible consortium defined sub-systems that could do the relevant work and get called from the BPEL processes. One example is verification that the sender is authorized to participate in the given process. This requires knowledge of the sender and access to some kind of partner profile. Another example is additional dictionary validation for the content of some message elements. It may also be useful to have a standardized validation sub-system.

The following are examples of additional embodiments for the present invention:

A WS-Security implementation must allow signature and encryption to be selectively applied to all elements of the SOAP message, including attachments. This allows full flexibility and adherence to current RNIF requirements. The WS-Security sub-system should also support WS-Policy/WS-SecurityPolicy.

A WS-Security specification can add non-repudiation support to its headers using the process described below.

A WS-ReliableMessaging specification can add a policy assertion for maximum number of retransmission attempts or max attempts may be a standard feature of most WS-ReliableMessaging sub-systems.

The present invention could be used to address the use of Debug Headers in Business Messages, as well as the persistence of Business Messages “per local policy” as specified by RNIF.

It is to be understood that the provided illustrative examples are by no means exhaustive of the many possible uses for my invention.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the embodiments described above, but encompasses any and all embodiments within the scope of the following claims:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A method for mapping an industry standard onto web services enabling the standard to be carried over into web services comprising:
using a subset of web services to enable an industry standard;
using elements from a central repository to be applied to multiple parties; and
using an abstract section of web services for each role in said industry standard.

13. The method of claim 12 further comprising the method of using binding and port information of said web services.

14. The method of claim 12 further comprising the method of modeling a business level receipt acknowledgement as an asynchronous web services invocation.

15. The method of claim 14 further comprising the method of using a receipt acknowledgement.

16. The method of claim 12 further comprising the method of using timing constraints.

17. The method of claim 12 further comprising the method of using message code values.

18. The method of claim 12 further comprising the method of using message instance ID values.

19. The method of claim 12 further comprising the method of providing fault handlers.

20. The method of claim 19 said method of providing fault handlers further comprises the method of providing notification to others.

21. The method of claim 12 further comprising the method of providing validation messages.
